(19) United States
(12) Patent Application Publication
(10) Pub. No.: US 2014/0180853 A1
(43) Pub. Date: Jun. 26, 2014

(54) Framework for Generating a Personalized Item List

(71) Applicant: WAL-MART STORES, INC., Bentonville, AR (US)

(72) Inventors: Connie Seidel, Springdale, AR (US); S. Saul Solis, Bentonville, AR (US); Nick Martin, Bentonville, AR (US)

(73) Assignee: WAL-MART STORES, INC., Bentonville, AR (US)

(21) Appl. No.: 13/721,368

(22) Filed: Dec. 20, 2012

(51) Int. Cl. G06Q 30/06

(52) U.S. Cl. CPC G06Q 30/0633
USPC 705/21; 705/26.8

(57) ABSTRACT

A framework 10 is disclosed for generating a personalized item list, such as a shopping list. The framework comprises an access point for acquiring customer transaction data, a data aggregator for collecting acquired customer transaction data, and a list generator that utilizes computational logic engineered to both process customer transaction data and change dynamically as a function of said data. The access points can be, but are not limited to, a retailer operated website, a retailer developed smartphone application, and external third-party operated websites. A method for implementing the computational logic utilizing expandable item class modules is also disclosed.

### FIELD

In general, the present invention relates to computer-based list generation, and in particular, to a framework for generating a personalized item list, such as a shopping list.

### BACKGROUND

There are currently available several retailer websites and retailer-developed smartphone applications that enable customers to create personal shopping lists. By providing customers with such time saving tools, retailers engender customer goodwill and loyalty, as well as augment their channels for acquiring valuable customer shopping data and feedback.

While these objectives are clearly worthwhile—providing economic advantages to both retailer and customer—in practice it has been observed that customer use of even freely distributed shopping list tools has not meet retailer expectations. While several factors may account for anemic uptake, it has been observed that, while customers continue to use handwritten or informally prepared shopping lists, they nonetheless appear to avoid electronic shopping assistants seemingly because of perceived difficulties in using the extant technologies and the lack of relevance of forecasted lists. In other words, customers are finding pen and paper easier and more accurate.

Shopping list applications today either rely heavily on substantial user input and/or predict future shopping needs based on inflexible and unchanging forecasting algorithms. Customers are unlikely to invest time and effort to input data into a shopping list tool when the expected result is essentially a low-value linear calculation of existing historical purchasing data, and/or when continuing use would involve additional maintenance and effort by the customer.

Need thus exists for methodologies and technologies for creating shopping lists that minimize mandatory customer input, whilst promoting continued customer use by dynamically improving list accuracy and/or relevance as a function of said use.

### SUMMARY

In response the above need, the present invention provides a framework 10 for creating a personalized item list (such as a shopping list). The framework comprises an access point for acquiring customer transaction data, a data aggregator for collecting acquired customer traction data, and a list generator that utilizes computational logic engineered to both process customer transaction data and change dynamically as a function of said customer transaction data.

The computational logic can be executed on customer transaction data that is passively acquired (i.e., with little if any substantive customer input) and will change dynamically in accommodation of additional instances of customer transaction data (i.e., modifying accuracy and/or relevance as a function of continued use).

In one particular embodiment, the framework comprises a customer account, the data aggregator, the access point, the list generator, and a customer interface. The customer account is assigned by a retailer to a customer and has a unique customer identifier. The customer interface is coded to recognize a customer through the unique customer identifier, and thereupon, enabling access to the customer account. The data aggregator is configured to aggregate customer transaction data 30 received from an access point. The access point is any point at which said customer can conduct a transaction directly or indirectly with said retailer using the customer account, whereupon customer transaction data is acquired, associated with the customer account, and transmitted to the data aggregator. The list generator—arranged in communication with the data aggregator—comprises computational logic capable of (a) generating the personalized item list utilizing the customer transaction data and (b) dynamically changing as a function of additional instances of acquired customer transaction data.

In light of the above, it is a principal object of the present invention to provide a framework for generating a personalized item list.

It is another object of the present invention to provide a framework for generating a shopping list, the framework including a list generator that incorporates computational logic capable of both processing customer transaction data for said list and changing dynamically as a function of said data.

It is another object of the present invention to provide a framework for generating a shopping list, the framework including a list generator that utilizes expandable item class modules capable of processing predetermined classes of customer transaction data, wherein the item class modules toggle between “active” and “inactive” states as a function of said customer transaction data.

It is another object of the present invention to provide a framework for generating a shopping list; the framework including a list generator capable of processing customer transaction data for said shopping list; the framework being in communication with a third party website originating said customer transaction data.

For a further understanding of the nature and objects of the invention, reference should be had to the following description taken in conjunction with the accompanying drawings.

### BRIEF DESCRIPTION OF THE DRAWINGS

FIG. 1 provides a schematic illustration of a framework 10 for generating a personalized item list 20 according to an embodiment of the present invention.

FIG. 2a provides a schematic illustration of the computational logic of a list generator 110, at a hypothetical “default” state, according to an embodiment of the present invention.

FIG. 2b provides a schematic illustration of the list generator 110 in FIG. 2a, after the hypothetical acquisition and processing of customer transaction data, according to an embodiment of the present invention.

FIG. 3 provides a schematic illustration of a framework 10 for generating a personalized item list 20, according to another embodiment of the present invention, wherein customer transaction data originates from an external third party source 320 and 310.

### DETAILED DESCRIPTION

The present invention discloses a framework for generating a personalized item list, such as a shopping list. The framework, in general, comprises an access point for acquiring customer transaction data, a data aggregator for collecting acquired customer traction data, and a list generator that utilizes computational logic engineered to both process customer transaction data and change dynamically as a function of said customer transaction data.

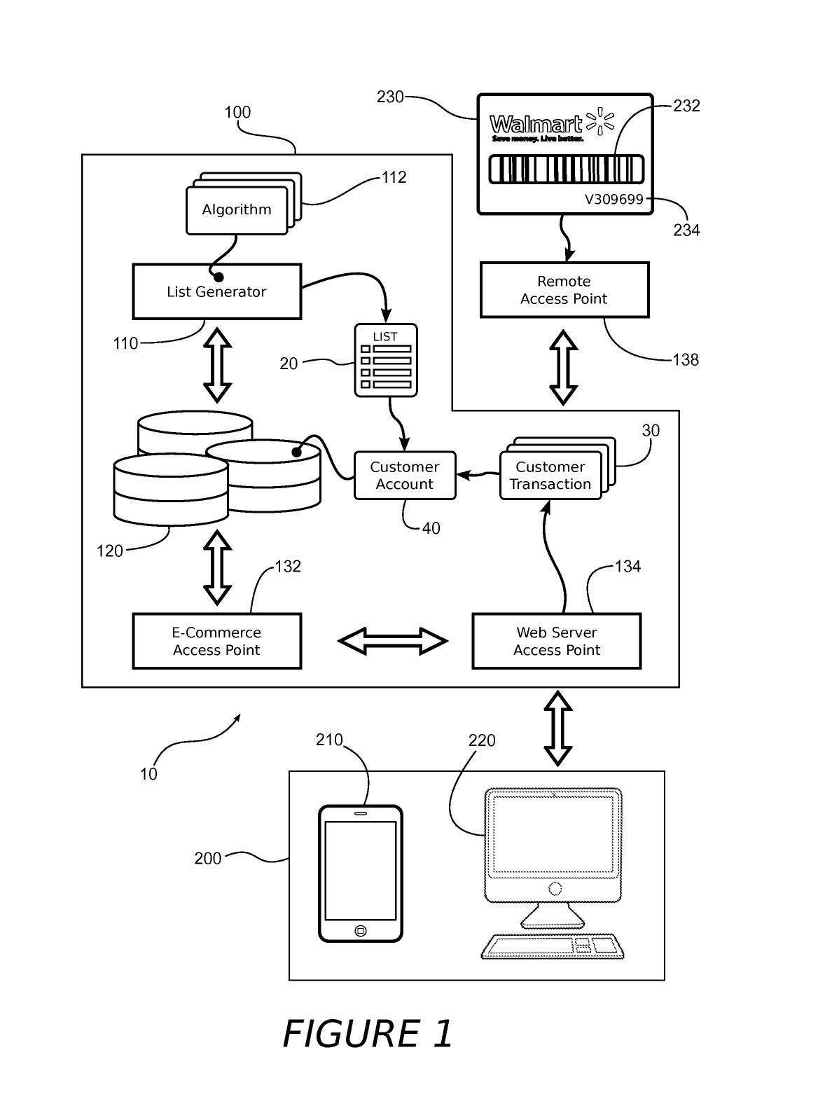

FIG. 1 is a schematic representation of the framework 10 according to one particular embodiment thereof.

As shown in FIG. 1, the framework 10 comprises a customer account, a data aggregator, an access point, a list generator, and a customer interface.

The customer account 40—which is typically assigned by a retailer to a customer—has both a unique customer identifier 234 and means for storing or having associate therewith customer transaction data 30.

The customer interface is coded to recognize the customer through the unique customer identifier, and thereupon, enable access to the customer account 40.

The data aggregator 120 is configured to aggregate customer transaction data 30 received from an access point. (See e.g., access points 132, 134, and 138).

The access point is any point at which a customer can conduct a transaction directly or indirectly with the retailer using said customer account 40, and whereupon, customer transaction data is acquired, associated with the customer account 40, and transmitted to the data aggregator 120.

The list generator 110 is arranged in communication with the data aggregator 120 and comprises computational logic 112 that is capable of (a) generating said personalized item list 20 utilizing collected customer transaction data 30 and (b) dynamically changing over time as a function of additional instances of the acquired customer transaction data 30.

The personalized item list 20 generated by the inventive framework can conform to various formats. It can be formatted as a list, a table, register, schedule, roster, menu, catalog, roll, inventory, digest, and the like. The items in the list can also vary. Though shopping lists are a key target of the invention, the personalized item list need not necessarily pertain exclusively to groceries and other consumer merchandise. Industrial and non-consumer goods and services are also contemplated.

Examples of personalized item lists include, an ingredient lists used by a food service organization in preparing daily menus, a components and parts list used by an OEM in the manufacture of its products, a raw materials list used by a contractor for building projects, a table of reagents and reactants used by a pharmaceutical company in drug production, and a grocery list used by a family for stocking a household pantry.

In the present invention, the personalized item list 20 is the calculated result of computations executed by the list generator 110 on acquired customer transaction data 30; reported following a predetermined layout, style, format, or template (e.g., columnar, tabular, ordered, unordered, filtered, unfiltered, chronological, alphabetical, etc.); and accessible by the customer from the framework 10 through the customer's personal account.

The personalized item list 20 can be generated and delivered at a customer request, and/or prepared and transmitted automatically without a customer prompt, for example, at a predetermined time period (e.g., monthly, weekly, biweekly, etc.).

Each item on the list may contain one or more of the following information fields: The product name, a product picture, the quantity of the product, the price of the product, a product SKU or like identification number, the product location (for example, the aisle in which product may be stocked at a local grocery store), and other like product information. Each item may also contain input fields, such as a checkbox (e.g., used by a customer to check off items retrieved from shopping) or a delete button (e.g., for removing an item listed on the shopping list).

To enable use of the framework, a customer of the retail operation is, upon application and enrollment, issued a customer account. Application can be done manually, for example, by filling out appropriate forms at a retailer operated department store. Alternatively, the customer can apply for membership by visiting and filling out an online application form at a retailer operated website. In either event, care should be adopted in requesting information that a customer may consider private or personal. Application forms preferably include terms establishing the bounds of customer privacy, as well as addressing non-disclosure (by the retailer) of non-aggregate customer data. Other methods for applying for and assigning customer account can be implemented by those skilled in the art in light of the present disclosure.

Customer accounts, when implemented in the context of a retail operation, should preferably provide access to a customer membership program offering a number of customer utilities and tools. Although the inventive framework may be only one of said utilities and tools, its novel functionality is capable of providing sufficient incentive and consideration towards the continued use and enrollment in the retailer's customer membership program as a whole. This is particularly important, where the customer membership program seeks to encourage customer loyalty through non-monetary incentives (e.g., availability, low “every day” pricing, convenience, etc.), rather than monetary incentives (e.g., cash back awards, reward points, discounts, etc.)

At the issuance of a customer account, the customer is assigned a unique customer identifier. To promote customer privacy, the unique customer identifier should preferably not be the customer's name, but rather a non-descriptive serial number or identification number. The customer's profile and access into the customer account is linked to or associated with the unique customer identifier.

When accessing the customer account online, the unique customer identifier can be used as a customer log-in name, together with a customer provided password. When accessing the customer account at a point-of-sale (see e.g., FIG. 1), the unique customer identifier (e.g., I.D. No. V309699)—typically printed 234 on a card 230 issued by the retailer—can be presented to a retail associate in person, for example, during checkout.

When a card 230 is used, the unique customer identifier can be recorded in a barcode 232 or magnetic stripe. For advanced applications, the unique identifier can be stored in a memory chip, embedded integrated circuits, NFC (“near field communication”) chips, RFID (“radio frequency identification”) tags, and the like. As an alternative to standard customer cards, small key ring cards (also known as “key tags”) can be employed for convenience in carrying and ease of access.

The customer account is stored within the retailer's computer network 10, preferably within the same storage facilities as the retailer's data aggregator 120. Records (or links and/or pointers thereto) are associated with or within the customer account providing information describing or pertinent to the customer's unique identifier, the customer's profile, and the customer's transaction data.

As used herein, “customer transaction data” is any information collected or created by or for the retailer in the course of or prompted by a customer's transaction with or directed towards the retailer. The transaction can be either an actual live transaction (e.g., purchasing merchandise at a checkout lane at one of the retailer's stores) or an electronic online transaction (e.g., purchasing merchandise at a retailer's e-commerce website).

The transaction need not be related to the purchasing of merchandise, but can also include, for example, the updating of a customer's online account profile, browsing pages on the retailer's website, reviewing or rating merchandise, enrollment in and transactions with third-party programs or clubs sponsored by or affiliated with the retailer, and patronage of a retailer's store. Although the types of transactions tracked can be vast, whether a class of transactions will be tracked will vary among retailers. As customer privacy is a paramount concern, the present invention is preferably practice utilizing only non-personal, non-intrusive, and appropriately transparent tracking, safeguarding any personal information volunteered by the customer, and with the customer ultimately dictating what and the degree to which tracking will occur.

The type of data at each customer transaction will vary depending on the type of customer transaction. For retailers, the most likely transaction of interest is the purchasing of merchandise. For such transactions, typical data collected could include: the customer's unique identifier; product names, class of goods, brands, suppliers, serial numbers and SKUs; the quantity and price of each product purchased; the date and time of the purchase; and the store location.

For non-purchase related transactions, data of interest could include: any personal information volunteered by a customer (e.g., name, age, gender, occupation, and address); product preferences and ratings (e.g., product name, product type, customer rating, etc.); retailer and affiliate website browsing history (e.g., html address, page views, “cookies”, online poll submissions, etc.); and third party program or club membership (e.g., program name, class, subject, product associations, etc.).

Data aggregator 120 provides a repository for customer transaction data acquired at the access points 132, 134, and 138 of retailer's computer network 100. This digital library may also compile information from stored internal customer data records and/or other detailed databases, libraries, and files on: customers; demographic buying patterns; retail supply and demand models; product consumption, fungibility, expiration, and utilization statistics; stochastic charts and tables; and other like information and data useful in forecasting customer needs. The customer transaction data can be stored in tables, records, lists, arrays, hashes, matrices, sets, stacks, and other digital data structures.

The data aggregator 120 can comprise one or more data storage devices capable of recording and retrieving digital information from a medium (e.g., magnetic, optical, semiconductor, etc.). For small to medium-scale retailers, the data aggregator 120 can utilize storage with modest capacity, such as provided by a single internal or external hard drive or flash drive. For large global retailers, the data aggregator will require more capacity and bandwidth, and thus, may employ several networked and attached electronic data storage components, these being deployed at an enterprise-scale and may include, for example, arrays of data servers and file servers; SAN and NAS storage facilities; RAID storage systems, data backup, archiving, and redundancy facilities; and data management and load balancing agents.

Acquired customer transaction data can be stored and retrieved from the data aggregator 120 utilizing well-known database technologies. Examples of data management tools for small to medium-sized retailers include consumer-grade software packages such as Microsoft Access, dBase, FileMaker Pro, and OpenOffice Base. For large global retailers, internal and external database design, development, and management can implement any of the various DBMS and models currently available based on SQL, NoSQL, MySQL, XML, OQL, and like database programming languages.

Customer transaction data 30 acquired at an access point can be transmitted to the data aggregator 120 directly or indirectly. Preferably, prior to storage, the data is processed within the retailer's network to, for example, promote form consistency, append other related information, error checking and correction, and performing any necessary or desirable calculations. As such, transformation of the customer transaction data 30 as received from (or as inputted by) a customer should be expected as it travels en route to the data aggregator 120 and ultimately imported into (or called by) the list generator 110.

Copies of the customer transaction data can also be—preferably, after being stripped off any personal identifiers—routed to other data collection devices, accumulated with other customer and retail-related data, and analyzed to determine patterns, relationships, hierarchies, correlations, distributions, probabilities, commonalities, deviations, averages, means, medians, frequencies, and other like statistical analytics, which can subsequently be used by the list generator 110.

Although such types of customer transaction data will not be associated with any particular customer account, when used in accordance with the present invention by the list generator 110, they will be used in combination with customer transaction data that does retains its association to a personal customer account, thereby providing personalization of resulting shopping list.

The list generator 100—which is in direct or indirect communication with the data aggregator 120—contains the instructions and algorithms 112 (i.e., programming code) that the retailer's network 100 executes (i.e., the network's arithmetical and logical processing units) on acquired customer transaction data 30, and which ultimately provides said personalized item list 20. This personalized item list 20 is associated by the list generator 100 to a customer account 40, such that it can be transmitted to or received by a customer communicating with (cf., “logged into”) the retailer's network at an access point 132, 134, and 138.

Depending on its specific code—which is intended to vary with design, deployment, and use—the list generator 100 may not necessarily contain code that actively links a resulting formatted list to a customer account 40, but rather tracks the source of the acquired customer transaction data 30 to a customer account 40, execute the appropriate algorithms, and return the results back to the same customer account 40. The actual list retrieved by or transmitted to the customer may contain formatting or other elements attributable, for example, to unrelated embedded programming (e.g., JavaScript, jQuery, etc.) in the HTML code of the retailer's website or similarly in the code of a smartphone mobile application. Despite the potential influence of unrelated external code on the formatting and presentation of the list, in accordance with the present invention, its content will be determined ultimately by code executed by the list generator 110.

Aside from its layout and format, the personalized item list 20 processed and defined by the list generator 110 may be “returned back” to the customer account 40 in unassembled components thereof at potentially different times. To Illustrate, processing by the list generator 110 can occur continuously and dynamically as customer transactions occur and are collected. Under most foreseeable circumstances, it would be inefficient (if not vexing) to continuously transmit an updated personalized item list to a customer at every instance of a transaction. Accordingly, it is preferred that the list generator 110 be engineered to deposit at a customer account 40 only components of the personalized item list 20. These components can be added contemporaneously as customer transaction data 30 is received and processed. The personalized item list 40 is not assembled from these components until either a predetermined time (e.g., a weekly or monthly publication) or prompted by a customer request (e.g., clicking a “shopping list” link on a retailer website).

In addition to processing customer transaction data, the list generator 110 also contains code that determines the algorithms 112 used to process the customer transaction data 100. This “controller code” will read available customer transaction data, preferably in combination with other information (e.g., the aforementioned “statistical analytics”), to determine which among a pool of algorithms should be used to process customer transaction data 40. This determination can be executed automatically every time the list generator 100 is called, or when prompted, for example, by the receipt of a tag, token, or key indicative of a customer authorization or preference.

The instructions and algorithms 112 executed by the list generator 110 together constitutes its “computational logic”.

The types of data processing algorithms 112 used for the computational logic will vary widely depending on desired functionality. But, in general, the data processing algorithms 112, independently or in predetermined groupings, will (a) input one or more of the collected customer transaction data; (b) compare the input to one or more of the aforementioned “statistical analytics”; and (c) effecting addition or removal of item from the personalized item list 20 based on the comparison. This base functionality—i.e., “inputting”, “comparing”, and “listing”—will be found in the algorithms 112 of the present inventions, independently or in predetermined groupings thereof.

An example of a data processing algorithm 112 would be a basic “product expiration” algorithm. Such algorithm will (a) have as inputs an identifier for a previously purchased product and the date on which the purchase was made, (b) compare the inputs with statistics on the consumption rate or lifespan of the product, and (c) effect addition of the product onto a product item list published to or requested by the customer on a date determined by the comparison.

Another example of a data processing algorithm would be a basic “related products” algorithm. Such algorithm will (a) have as an input an identifier for a previously purchased product, (b) compare the input with statistics on cross product purchasing patterns and probabilities, and (c) effect addition of a different product onto a product item list based on the comparison.

While these two example, for purposes of illustration, each involves a single algorithm performing a linear sequence of “inputting”, “comparing”, and “listing”, in practice several algorithms may be involved to perform these function recursively, in parallel, sequentially, or in stages, and can call upon or utilize several and varied statistical and customer transaction data records. Independently or as a group, the data processing algorithms “start” with customer transaction data and “end” with a listing determination.

It will be appreciated that with initial uses of the inventive framework, the resulting product item list would be generated on a comparatively small pool of customer transaction data. The pool however will grow with continued use. Continued use, together with additional customer interactions (e.g., voluntary customer profile submissions), will also improve list accuracy and relevance by prompting change and refinement of the data processing algorithms 112 executed by the list generator 110.

More particularly, as indicated at the outset, unlike prior electronic shopping list technologies, the computational logic of the list generator 110, is engineered to “dynamically change as a function of collected customer transaction data”.

Thus, when the invention is first used by a customer after enrolling into retailer program, the framework 10 will provide a personalized item list 20 that is based on a default set of data programming algorithms (e.g., hypothetical algorithms g1, g2, and g3, not illustrated) executed on a starting selection of customer transaction data (e.g., hypothetical data type “g” (not illustrated)) to produce an initial personalized item list (e.g., listing hypothetical items g10, g20, and g30, not illustrated).

However, after a period of use and collection of further customer transaction data (e.g., hypothetical data types “g” and “h”), the framework 10 when called will provide a personalized item list 20 that is based on a different set of algorithms (e.g., hypothetical algorithms g1, g3, a1, h6, and h8) executed on a different selection of customer transaction data (e.g., hypothetical data types “g” and “h”) to produce a personalized item list listing different item types (e.g., hypothetical items g10, a10, h60, and h80).

In accordance with the present invention, the change in the set of algorithms executed (e.g., the removal of hypothetical algorithm g2 and the addition of hypothetical algorithms a1, h6, and h8) is a function of additional instances of collected customer transaction data (e.g., receipt of hypothetical data types “g” and “h”).

From the above illustration, the “dynamic change of computational logic” is shown clearly to involve a change in the executable set of data processing algorithms 112 caused by customer transaction data. The change can be either the removal of an algorithm (e.g., the removal of algorithm g2 caused hypothetically by the receipt of data type “h”) or the addition of an algorithm (e.g., the addition of algorithm a1 caused hypothetically by receipt of another instance of data type “g”).

In sum, in the present invention, customer transaction data 20 function both as a value (cf., an operand) and an agent of change.

In one embodiment of the present invention, the data processing algorithms 100, individually or in modifiable groupings, can be coded to have “active” and “inactive” states. In their inactive state, the processing algorithms will not perform any of their aforementioned base functions of “inputting”, “comparing”, and “listing”. When set to their “active” state, either by default or triggered by customer transaction data, base functionality is actuated.

In another embodiment of the present invention, the data processing algorithms are distributed amongst predetermined item class modules. The item call modules will be responsible for processing a specific predefined class of retail merchandise. Retail merchandise classes will generally track the well known retail department classes, examples including: Grocery, Automotive, Health Care, Household, Electronics, Computers, Office, Apparel, Toys, and the like. Overlap in the merchandise covered within these class is expected. Similarly, data processing algorithms can be used in more than one item class module.

Each of the item class modules, like the data processing algorithms 112, are coded to have an “active” and “inactive” state. When set to their “active” state, access to data processing algorithms 112 associated therewith is enabled. These algorithms—though accessible—remain themselves either “active” or “inactive”. When the item class module is set to its “inactive” state, access to the data processing algorithms associated therewith is disabled. These algorithms—though inaccessible—may be accessible through another “active” item class module with which they are also associated.

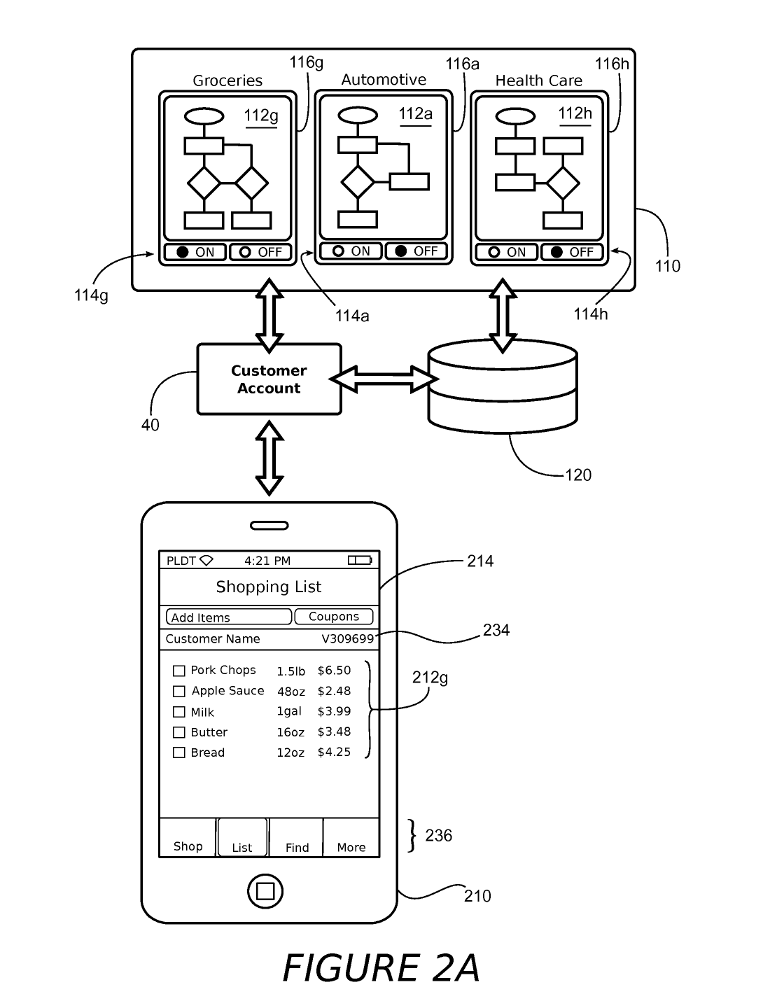

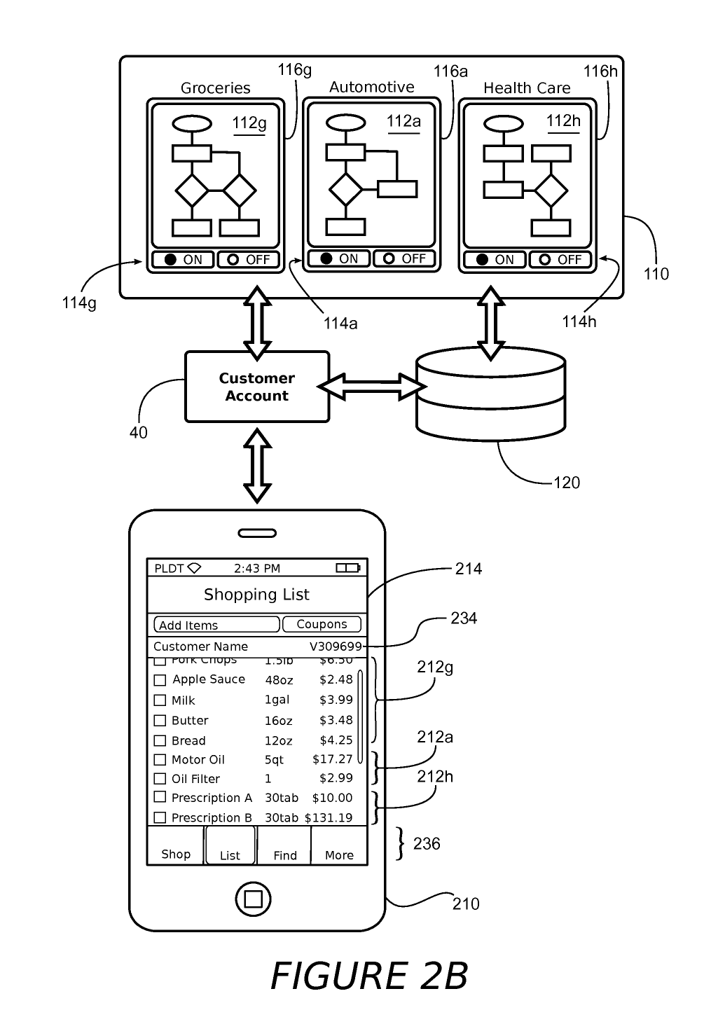

An illustration of the operation of inventive framework utilizing item class modules 116g, 116a, and 116h is provided in FIG. 2a and FIG. 2b.

In FIG. 2a, an item list generator 110 is shown comprising item class modules 116g, 116a, and 116h. Each of the item class modules 116g, 116a, and 116h comprises a set of data processing algorithms useful for processing a pre-definable set of customer transaction data (illustrated representatively at 112g, 112a, and 112h) and coded to be switchable between “active” and “inactive” states (illustrated representatively at 114g, 114a, and 114h).

When a customer first enrolls into a retailer programs, a customer account 30 is initiated. As shown in FIG. 2a, the customer account 40—hosted in the retailer's computer network at data storage 120—is in communication with and thus accessible by the list generator 110. At the time of initiation, the item class modules 116g, 116a, and 116h of list generator 110 are set preferably at a default state, wherein switch status 114g is “on” and switch status 114a and switch status 114h are both “off” (i.e., the “grocery module” is “active” and both “automotive” and “health care” modules “inactive”).

In FIG. 2a, the customer interfaces with customer account 40 utilizing a smartphone mobile application 214 installed onto a smartphone device 210—the view illustrated being entitled “Shopping List”. The mobile application 214 “logs into” customer account 40, for example, by passing on a login account (e.g., account number 234) and password as submitted by the customer. Navigation button 236 are also provided, giving access to the mobile app 214's “Shop”, “List”, “Find”, and “More” sections.

As illustrated in FIG. 2a, the “List” button is currently “clicked”, giving access to the list generator 110 through customer account 40, and at which point a personalized item list is generated based on the then default state of the item class modules, and the result thereof being transmitted back to and displayed on mobile app 214. As can be seen, with only the “grocery module” set to an “active” state, the resulting list 212g contains only “grocery module” item results.

FIG. 2b represent the same customer, framework, and mobile application as in FIG. 2a, but at a later point in time.

In particular, after use by the customer of the mobile application 214, including its “Shopping List” function, as well as other customer activities (such as shopping, uploading shopping receipts, and volunteering additional information to one's customer profile), much customer transaction data has been received into the framework and aggregated at data storage facility 120. Due to the inflow of such customer transaction data, unlike the situation at the time of FIG. 2a, both the “automotive” and “health care” class module have been activated. In particular, switch status 114a and switch status 114h are now both “on”.

The “groceries” class module 116g—still “active” with switch status 114g still toggled “on”—calls and processes relevant customer transaction data stored at data aggregator 120 and ultimately effects product list items 212g displayed on mobile app 214. Likewise, the “automotive” class module 116a—now “active” with switch status 114g now toggled “on”—calls and processes its relevant customer transaction data stored at data aggregator 120 and ultimately effects product list items 212a displayed on mobile app 214. And, likewise, the “health care” class module 116a—also now “active” with switch status 114g also now toggled “on”—calls and processes its relevant customer transaction data from data aggregator 120 and ultimately effects product list items 212p displayed on mobile app 214.

“Dynamic change” is evident from default to the time at FIG. 2b. One can expect further change with further use.

For example, the customer at FIG. 2b can use the shopping list to go shopping, but may decide not to purchase one of the listed item, for example, “Prescription A”. This pattern may continue again and at some point in time, the framework decides that due to this pattern, as well as possible corroboration suggested statistically by other customer transaction data, the algorithms 112h associated with health care module 116h need to be adjusted or otherwise modified by turning some “on” and/or some “off” to accommodate for the “false positive” or otherwise unwanted or unnecessary listing of “Prescription A”. Such change is performed by the framework dynamically and with minimal (if any) mandatory active inputting by a customer.

An approach for effecting the activation or de-activation of an item class module would be to scan customer transaction data to determine the presence or absence of predetermined digital indicia (e.g., a keyword string), the presence or absence of said predetermined digital indicia triggering said activation or de-activation. Similarly, ranges of the customer transaction data can be scanned collectively to determine the presence or absence of predetermined patterns of digital indicia, for example, seasonal purchasing patterns.

Customer transaction data 30 received by the framework 10 is collected at one or more access points 132, 134, and 138. As stated above, it is at the access points where customers conduct transactions with the retailer. Contemporaneously with these transactions, data is acquired, associated with the customer's account, and transmitted directly or indirectly or otherwise made accessible to the retailer's data aggregating facility 120.

The access points can be provided within the core of retailer's network (e.g., a web server hosted on a core server), or more distantly, such as at the network edge and/or beyond a firewall (e.g., a remote department store access point). Two preferred embodiments are “internet access points” and “physical point-of-sale access point”.

An example of an “internet access point” is an online e-commerce website. An e-commerce website can be hosted on and accessed directly through a dedicated e-commerce web server (cf., e-commerce access point 132 in FIG. 1) and/or through a comparatively broader-functionality web server linked to the e-commerce web facility (cf., web server access point 134 in FIG. 1). In the later case, it will be appreciated that a web site with no e-commerce function can still serve as an “access point”. As stated, the present invention does not require “customer transaction data” to be related to purchasing merchandise. Any interaction with the retailer at an access point could potentially be recorded as “customer transaction data”. Thus, interacting with a retailer web site—for example, by using means provided therein for inputting customer profile data, or scanning and uploading a sales receipt, or browsing and download store coupons—can potentially lead to collected customer transaction data.

An example of a “physical point-of-sale access point” is an electronic checkout register at a retailer-operated store. Such checkout register would be linked to or otherwise in communication with the retailer's core network 100 and will generally comprise a credit card reader, a receipt printer, a barcode scanner, and a PIN pad with integrated card swipe.

At the point of sale, access into the customer's personal account 40 is authorized or otherwise enabled by the customer by presenting appropriate account identification to a designated sales associate. The customer account number (or equivalent thereof) can be presented either verbally or by presenting or scanning a customer account card 230 bearing one or more account identification indicia. As shown in FIG. 1, the account identification indicia can be in the form of human-readable alphanumeric text 234 and/or machine-readable code 232. A customer name can also be present, but for many reasons, including improving customer privacy and lacking necessity, it is often advantageously omitted.

Once the customer account is recognized, customer transaction data 30 acquired from checkout can be transmitted to the retailer's data aggregation facilities 120 in association with the customer account 40. Customer transaction data 30 typically collected at checkout would be product-related, quantity-related, and price-related data. This data itself can be compared with prior customer purchasing data in order to update, add to, or subtract from already extant customer transaction data.

At each access node, a customer interface will moderate access to a customer's account. The customer interface, among other functions, will be coded to recognize customers through an input of their unique customer identifiers, and thereupon provide said access. The input can be made either directly or indirectly. For example, a customer will likely input her customer account number (and password) on login page on a retailer-operated e-commerce website herself, whereas at a checkout station at a retailer operated store, the customer would present her customer card to a sales associate who would be the actual individual responsible for scanning or inputting the card number. The input can also be accomplished automatically without any substantive customer or associate involvement, such as through use of a token, tag, key fob, or medallion containing an RFID chip that is read automatically when presented or in proximity to an RFID reader.

The access node and customer interface can be embodied in a household appliance, such as a mountable tablet, web appliance, or internet device integrated or otherwise capable of communicating with the retailer's network 10. Examples of such appliances can be found, for example, in U.S. Pat. No. 7,325,077, issued to J. T. Nguyen on Jan. 29, 2008; U.S. Pat. No. 7,260,604, issued to H. Kuki on Aug. 21, 2007, U.S. Des. Pat. No. D14343, issued to S. K. Chang on May 15, 2001; U.S. Pat. No. 6,640,250, issued to S. K. Chang on Oct. 28, 2003, and U.S. Pat. No. 6,934,740, issued to S. Lawande on Sep. 19, 2000.

In another embodiment of the inventive framework, customer transaction data 30 is derived from a third-party source (e.g., a third-party web site) that is external to the retailer's network. The third-part source records, logs, or otherwise collects customer information, which upon appropriate authorization by the customer, can be shared as customer transaction data with the retailer's framework. As a matter of policy, the sharing of information would be regulated, governed, moderated, or otherwise determined by mutual agreement between the retailer and the owner of the third-party source.

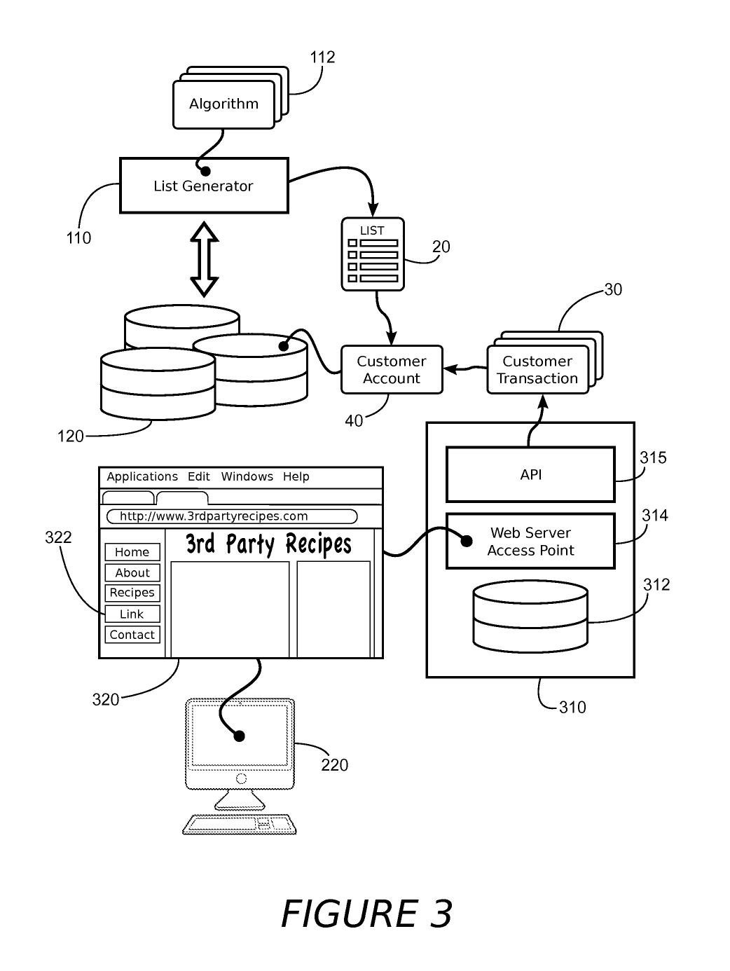

An example of the “third-party source” embodiment is illustrated in FIG. 3.

In particular, FIG. 3 illustrates a third party website 320, entitled “3rd Party Recipes”, and—similar to many currently existing recipe websites—provides users access to a library of recipes, which can be searched, sorted, and browsed, and which provides both instructions and a list of ingredients. A user of this website, accessing it through a web browser on a personal computer 220, would have available standard website features, buttons and functionalities (e.g., searching, navigation, content, user registration, contact links, and the like.) For the inventive framework, the third party website would also have means for linking or associating a user's account or registration at the third-party website 320 with the retailer's network, such as represented by link button 322.

The third party website is published and accessed by a customer from a third-party operated web server 310 provided on a third-party operated network 310. User activity on the third-party website, when authorized, is captured and recorded onto a third-party operated data storage facility 312. If the user account on the third party website is linked or otherwise associated with a customer account on the retailer's network, user activity information stored on the third-party operated data storage facility 312 can be shared with, transmitted to, or received from the retailer through an API (“application programming interface”) 315. As mentioned, the parameters for such API will largely be dictated by agreement and executed subject to customer/user authorization. Other means for enabling machine-to-machine network interaction can of course be employed instead of an API.

Once accessed within the retailer network, the user activity information can be sorted, filtered, modified, amended, compiled, divided, corrected, and/or otherwise processed, then stored within the retailer data storage facility 120 as additional instance of customer transaction data 30 linked to otherwise associated with an appropriate customer account 40. As with other customer transaction data, the third-party originated data 30 is available to the retailer's list generator 110 for processing through the computational logic 112 therein to create or otherwise provide for a personalized item list 20.

Whether customer transaction data originates externally from a third-party source or is received directly from the customer through a retailer access point, the accuracy and relevance of any resulting personalized item list will rely largely on the quantity and quality of collected customer transaction data. To encourage quantity and quality, engineering of the framework is desirably combined with other consumer-related tools and utilities that together engage and attract customer interest and use. This can be accomplished by providing said other utilities and tools at the retailer's website or smartphone application.

The mobility of smartphone devices provides a particularly fertile platform for developing customer-friendly shopping applications that could combine or integrate well with the inventive framework. Examples of desirable shopping-related utilities would include bar code or QR code readers for scanning price tags, labels, and receipts; price checkers and comparators; mapping and/or routing tools for guiding customers to item locations within a store; personal budgeting planners and calculators; e-coupon locators and digital wallets; and utilities for forwarding a personalized item list generated by the inventive framework to a retailer operated store or warehouse for fulfillment and delivery to or pick-up by the customer.

Although several embodiments of the invention are disclosed hereinabove, those skilled in the art having the benefit of this disclosure can effect modifications thereto. These modifications are to be construed as being encompassed within the scope of the present invention as set forth in the appended claims.

1. A framework for generating a personalized item list, the framework comprising:
a customer account assigned by a retailer to a customer and having a unique customer identifier;
a data aggregator configured to aggregate customer transaction data;
an access point at which said customer can conduct a transaction with said retailer using the customer account, the access point capable of acquiring customer transaction data when said customer conducts said transaction, the customer transaction data being associated with the customer account;
a list generator in communication with the data aggregator and comprising computational logic capable of generating said personalized item list utilizing the customer transaction data, the computational logic also capable of dynamic change as a function of said customer transaction data; and
a customer interface capable of recognizing said customer through an input of the unique customer identifier, and whereby access to said personalized item list by said customer is enabled.

2. The framework of claim 1, wherein the personalized item list is a shopping list of merchandise available for purchase from said retailer.

3. The framework of claim 2, wherein the computational logic comprises a set of data processing algorithms, and wherein the dynamic change is an increase or decrease in said set of data processing algorithms.

4. The framework of claim 1, wherein the computational logic comprises a plurality of item class modules, each item class module comprising a set of data processing algorithms useful for processing the customer transaction data; and wherein the dynamic change is an increase or decrease in the number of item class modules.

5. The framework of claim 4, comprising a plurality of said access points, said plurality including (a) a point-of-sale access point and (b) an internet-based access point.

6. The framework of claim 5, wherein the internet-based access point includes means for inputting customer profile data into said customer account, said customer profile data being available to said data aggregator for creation of customer transaction data.

7. The framework of claim 6, wherein the personalized item list is a shopping list of merchandise available for purchase from said retail operation.

8. The framework of claim 1, wherein the data aggregator is capable of receiving customer transaction data originated from an external internet-based access point outside a retailer network hosting the framework, said customer transaction data being originated from the external internet-based access point as a function of authorization by said customer.

9. The framework of claim 8, wherein the external internet-based access point is a website capable of sharing information with the retailer network through an application programming interface.

10. A method useful in the generation of a personalized item list, the personalized item list being generated by a list generator from customer transaction data utilizing computational logic that dynamically changes as a function of said customer transaction data, the method comprising the steps of:
providing a plurality of item class modules into said computational logic, each item class module comprising a set of data processing algorithms, each item class module capable of processing a pre-definable class of customer transaction data, each item class module being switchable between an active state and an inactive state;
initiating a customer account providing access to a customer to said list generator, the computational logic of said list generator comprising a default set of said item class modules, the default set consisting of item class modules switched to their active state at said initiation of said customer account;
acquiring customer transaction data at an access point; and
changing the computational logic of said list generator automatically after acquisition of customer transaction data, the change comprising either (a) switching an item class module in said default set from its active state to its inactive state, or (b) switching an item class module outside said default set from its inactive state to its active state.

11. The method of claim 10, wherein the personalized item list is a shopping list of merchandise available for purchase from a retailer.

12. The method of claim 11, wherein the collected customer transaction data is scanned to determine the presence or absence of predetermined digital indicia, the presence or absence of said predetermined digital indicia triggering the change of said computational logic.

13. The method of claim 11, wherein the collected customer transaction data is aggregated over time and scanned to determined the presence or absence of predetermined patterns of digital indicia, the presence or absence of predetermined patterns triggering the modification of said computational logic.

14. The method of claim 12, wherein the predetermined digital indicia is a keyword string.

15. The method of claim 11, wherein said customer transaction data is acquired at a point-of-sale access point provided by said retailer, and wherein the customer transaction data includes a date, a time, a merchandise name, and a merchandise quantity.

16. The method of claim 11, wherein said customer transaction data is acquired at a internet-based access point provided by said retailer.

17. The method of claim 11, wherein said customer transaction data is acquired from an external website capable of sharing information, through an application programming interface, with a retailer network hosting said list generator.
